(19) United States
(12) Patent Application Publication
(10) Pub. No.: US 2026/0225143 A1
(43) Pub. Date: Aug. 6, 2026

(54) ALUMINUM BLANKS WITH REINFORCEMENT PATCHES

(71) Applicant: MAGNA INTERNATIONAL INC., Aurora (CA)

(72) Inventors: Edward SCHLEICHERT, Sailauf, Bavaria (DE); Stephan KAUFHOLD, Sailauf, Bavaria (DE)

(21) Appl. No.: 19/148,426

(22) PCT Filed: Jan. 16, 2024
(86) PCT No.: PCT/CA2024/050041

§ 371 Date: Jul. 16, 2025

Related U.S. Application Data
(60) Provisional application No. 63/439,334, filed on Jan. 17, 2023.

(51) Int. Cl. B21D 22/02; B23K 11/11; B23K 26/244; B23K 101/18; B23K 103/10

(52) U.S. Cl. CPC B21D 22/022; B23K 11/11; B23K 26/244; B23K 2101/185; B23K 2103/10

(57) ABSTRACT

A method of manufacturing a reinforced aluminum part, such as a part for a vehicle, from a reinforced blank is provided. The method includes forming the reinforced blank by friction stir welding, spot welding, or laser welding a reinforcement patch to a base. Both the reinforcement patch and the base are formed of aluminum or aluminum alloy. After the welding step, the method includes warm forming or hot forming the reinforced blank in a die to form the reinforced part. The base and the reinforcement patch are formed in a single step, which reduces amount of equipment and time required to manufacture the reinforced part.

### CROSS-REFERENCE TO RELATED APPLICATIONS

This PCT International Patent Application claims the benefit of and priority to U.S. Provisional Patent Application Ser. No. 63/439,334, filed Jan. 17, 2023, titled “Aluminum Blanks With Reinforcement Patches,” the entire disclosure of which is hereby incorporated by reference in its entirety.

### BACKGROUND OF THE INVENTION

### 1. Field of the Invention

The present invention relates to an aluminum blank with a reinforcement patch, a method of manufacturing the aluminum blank with the reinforcement patch, a part formed from the aluminum blank including the reinforcement patch, such as a part for use in a vehicle, and a method of manufacturing the part by warm forming or hot forming the aluminum blank with the reinforcement patch.

### 2. Related Art

This section provides background information related to the present disclosure which is not necessarily prior art.

Aluminum parts, such as parts for use in vehicles, are often formed from blanks of aluminum or aluminum alloy. The method of manufacturing the parts can include warm forming the aluminum blank to achieve a desired shape, or hot forming the aluminum blank to achieve the desired shape. The warm and hot forming processes typically include heating the aluminum blank in a furnace, and then transferring the heated aluminum blank to a forming device, such as a stamping press. The warm forming process typically includes forming the aluminum blank in a die while the aluminum blank is at a temperature ranging from 170° C. to 230° C. The hot forming process typically includes forming the aluminum blank in the die while the aluminum blank is at a temperature ranging from 400° C. to 500° C., followed by quenching the hot formed part in the die.

Oftentimes, aluminum parts, such as those for use in vehicles, require different properties in different areas of the part. For example, the aluminum parts may require higher strength in certain areas than others. One technique used to achieve the different properties includes cold forming an aluminum component, forming an aluminum reinforcement patch, and then joining the formed aluminum reinforcement patch to the cold formed aluminum component in an area of the component that benefits from the additional strength. However, other methods and techniques for achieving the different properties are desired.

### SUMMARY

This section provides a general summary of the disclosure and is not to be interpreted as a complete and comprehensive listing of all of the objects, aspects, features and advantages associated with the present disclosure.

One aspect of the subject disclosure provides a method of manufacturing a reinforced blank formed of aluminum-based material. The method includes the steps of joining a reinforcement patch formed of aluminum-based material to a base formed of aluminum-based material prior to any forming step.

Another aspect of the disclosure provides a reinforced blank formed of aluminum-based material. The reinforced blank includes a reinforcement patch formed of aluminum-based material joined to a base formed of aluminum-based material.

Another aspect of the disclosure provides a method of manufacturing a reinforced part formed of aluminum-based material. The method includes joining a reinforcement patch formed of aluminum-based material to a base formed of aluminum-based material to provide a reinforced blank followed by hot forming or warm forming the reinforced blank.

Another aspect of the disclosure provides a reinforced part formed of aluminum-based material. The reinforced part includes a reinforcement patch joined to a base, wherein both the reinforcement patch and the base are formed of aluminum-based material.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is an example of a reinforced blank including a reinforcement patch prior to joining the reinforcement patch to the base and after joining the reinforcement patch to the base;

FIG. 2 is an example of a reinforcement patch provided in the form of a tailor welded blank;

FIG. 3 is an example of a reinforcement patch provided in the form of a tailor rolled blank;

FIG. 4 shown an example of a friction stir welding step;

FIGS. 5A-5C include examples of friction stir welded joints; and

FIGS. 6A-6I include examples of reinforced parts which can be formed from the reinforced blank according to example embodiments.

### DETAILED DESCRIPTION OF THE EXAMPLE EMBODIMENTS

Example embodiments will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

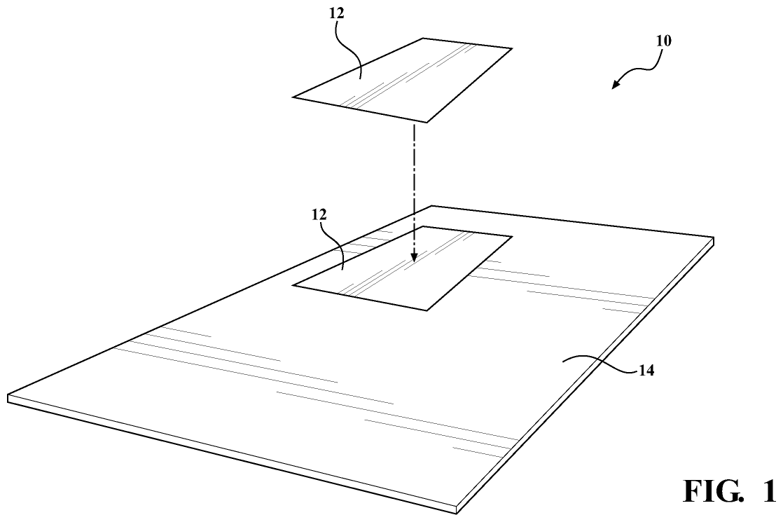

One aspect of the subject disclosure provides a method of manufacturing a reinforced blank 10 formed of aluminum-based material. The reinforced blank 10 includes a reinforcement patch 12 joined to a base 14 which are both formed of aluminum-based material. The reinforcement patch 12 may have the same as or different properties compared to the base 14. The strength of the reinforcement patch 12 can be the same as, higher, or lower than the strength of the base 14. Typically, the reinforcement patch 12 is used to provide additional strength in specific areas of the reinforced blank 10. An example of the reinforced blank 10 including the reinforcement patch 12 joined to the base 14 is shown in FIG. 1.

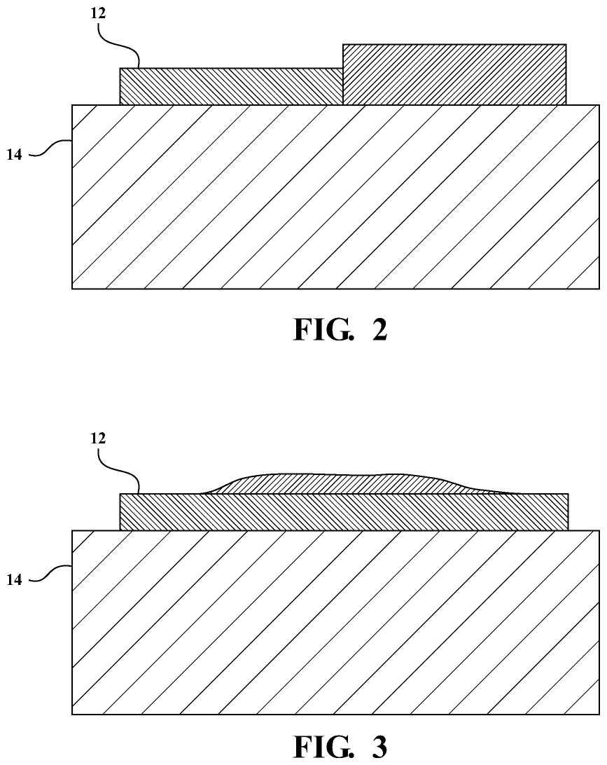

The reinforcement patch 12 and the base 14 are both formed of aluminum-based material. The aluminum-based material of the reinforcement patch 12 can be the same as or different from the aluminum-based material of the base 14. Aluminum-based materials that can be used to form the reinforcement patch 12 and the base 14 include aluminum and aluminum alloys. According to example embodiments, the base 14 and/or the reinforcement patch 12 are formed of an aluminum alloy having a 5xxx, 6xxx, or 7xxxx grade. The base 14 of the reinforced blank 10 typically has a thickness ranging from 0.7 millimeters (mm) to 4.0 mm. The reinforcement patch 12 of the reinforced blank 10 also typically has a thickness ranging from 0.7 mm to 4.0 mm. Further, the reinforcement patch 12 can have various different shapes prior to being joined to the base 14. According to one embodiment, the reinforcement patch 12 is provided as a tailor welded blank, as shown in FIG. 2. The tailor welded blank includes two or more pieces of material welded together. Thus, the tailor welded blank can include one or more weld joints, multiple thicknesses, and/or multiple strengths. According to another embodiment, the reinforcement patch 12 is provided as a tailor rolled blank, as shown in FIG. 3. The tailor rolled blank includes two or more pieces of material rolled together. Thus, the tailor rolled blank can include multiple thicknesses and/or multiple strengths.

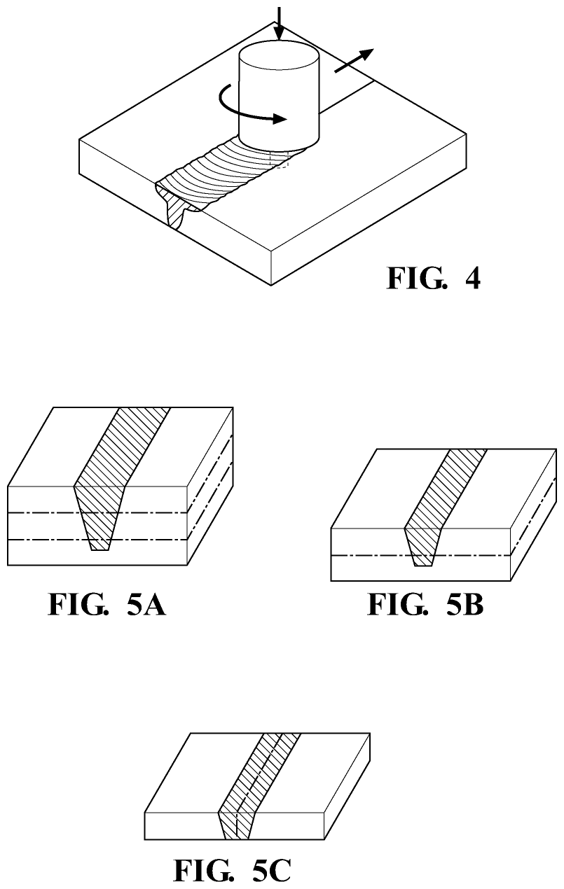

Various methods can be used to join the reinforcement patch 12 to the base 14 and thus form the reinforced blank 10. According to example embodiments, the method includes joining the reinforcement patch 12 to the base 14 by welding. The welding step can include friction stir welding, spot welding, and/or laser welding. The welds formed by the friction stir welding or laser welding can be small local spots, stepped lengths, i.e. stiches, or a continuous line. FIG. 4 shows an example of friction stir welding, wherein the weld is a continuous line. FIGS. 5A-5C include examples of friction stir welded joints. The reinforced blank 10 can then be used to manufacture a reinforced part 16, such as a part for use in a vehicle application.

After joining the reinforcement patch 12 to the base 14 to form the reinforced blank 10, the method of manufacturing the reinforced part 16 includes warm forming or hot forming the reinforced blank 10 with the reinforcement patch 12 connected. Joining the reinforcement patch 12 to the base 14 prior to warm forming or hot forming requires less work and equipment compared to a process which includes forming the reinforcement patch 12 separate from the base 14, and then joining the reinforcement patch 12 to the base 14 after the forming steps. One less forming tool is required when the reinforcement patch 12 is joined to the base 14 prior to the warm or hot forming step.

The warm forming process typically includes heating the reinforced blank 10 in a furnace, and then transferring the heated reinforced blank 10 to a forming device, such as a stamping press. The warm forming process typically includes forming the reinforced blank 10 in a die while the reinforced blank 10 is at a temperature ranging from 170° C. to 230° C.

The hot forming process typically includes heating the reinforced blank 10 in a furnace, and then transferring the heated reinforced blank 10 to a forming device, such as a stamping press. The hot forming process typically includes forming the reinforced blank 10 in the die while the reinforced blank 10 is at a temperature ranging from 400° C. to 500° C. to form the hot formed reinforced part 16, followed by quenching the hot formed part 16 in the die. According to example embodiments, the step of heating the reinforced blank 10 is convection heating, jet heating, or contact heating.

The method of manufacturing the reinforced part 16 can also include pre-heating a portion of the reinforced blank 10 including the reinforcement patch 12 prior to heating the entire reinforced blank 10 in the furnace. For example, the reinforced area can be pre-heated prior to heating the entire reinforced blank 10 in the main furnace to ensure homogeneous heating of the entire reinforced blank 10 and an optimum cycle time. According to an example embodiment, the reinforcement patch 12 or the entire reinforced blank 10 can be coated with a heat absorbing coating, prior to heating, which will enhance and improve heat absorption during the heating steps. The method can also include enhancing the surface structure of the reinforced blank 10. For example a heat resistant coating which is dark in color, or possibly colorless, can be applied to the reinforcement patch 12 to allow for homogeneous heating of the entire reinforced blank 10. Another technique that can be used to improve heat absorption during the heating process includes applying a surface enhancing treatment, such as anodizing, to the reinforcement patch 12 or the entire reinforced blank 10. A mechanical modification of the surface roughness of the reinforcement patch 12 or the entire reinforced blank 10 can also improve heat absorption The method can also include post-heating the portion of the reinforced blank 10 including the reinforcement patch 12 after heating the entire reinforced blank 10 in the furnace.

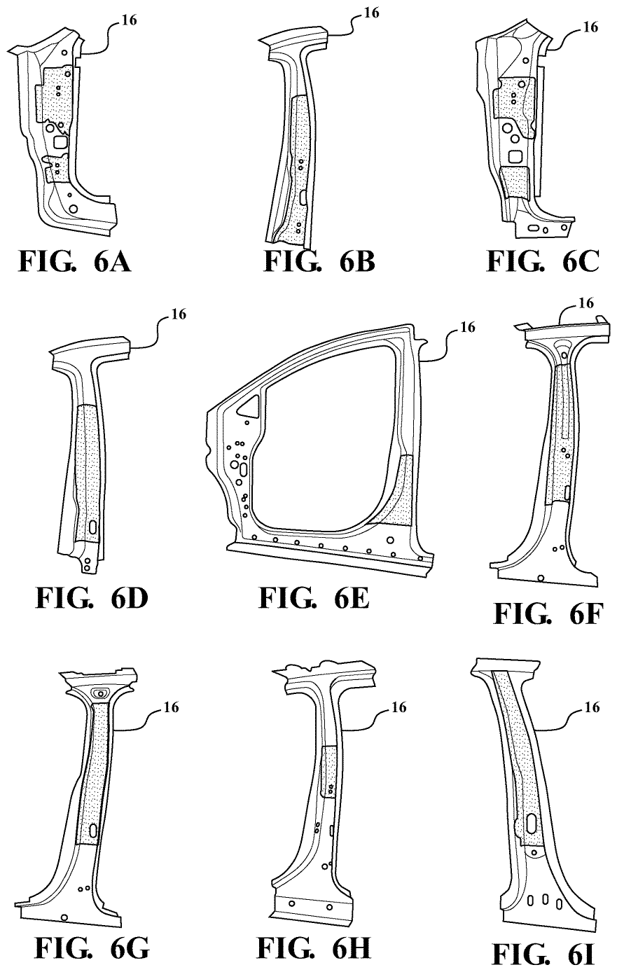

The forming device used to form the reinforced blank 10 can be a stamping or pressing tool which includes a die that is designed to accommodate the shape of the reinforced blank 10 with the reinforced patch 12. When the process includes hot stamping, the cooling in the area of the reinforcement patch 12 is adjusted to adequately cool and quench the area containing the reinforcement patch 12 and achieve an optimum cycle time. After forming the reinforced blank 10, the method can include additional processing of the reinforced blank 10, such as laser cutting. The reinforced blank 10 can be used to manufacture various types of the reinforced parts 16, such as those for use in vehicle applications. Parts 16 formed from the reinforced blank 10 can be used to form a body structure of a vehicle, for example an A-pillar, A-pillar reinforcement, side member, B-pillar, B-pillar reinforcement, hinge pillar, roof rail, header, roof bow, door ring, double door ring, front rail, rear rail, side reinforcement, rocker rail, rocker panel, firewall upper, firewall lower, firewall reinforcement, tunnel, and tunnel reinforcement. Parts 16 formed from the reinforced blank 10 can also be used as components of battery electric vehicles (BEV) and electric vehicles (EV), for example a side member of a battery tray, cross member of a battery tray, reinforcement of a battery tray, corner reinforcement, battery tray cover, and battery tray cover reinforcement. Examples of reinforced parts 16 that can be formed from the reinforced blank 10 described herein are shown in FIGS. 6A-6I.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A method of manufacturing a reinforced part, comprising the steps of:
joining a reinforcement patch formed of aluminum-based material to a base formed of aluminum-based material to provide a reinforced blank, and
hot forming or warm forming the reinforced blank.

2. The method of claim 1, wherein the reinforcement patch is formed of an aluminum alloy having a 5xxx, 6xxx, or 7xxxx grade; and the base is formed of an aluminum alloy having a 5xxx, 6xxx, or 7xxxx grade.

3. The method of claim 1, wherein the reinforcement patch has a higher strength in one area of the reinforcement patch compared to another area of the reinforcement patch.

4. The method of claim 1, wherein the base of the reinforced blank has a thickness ranging from 0.7 mm to 4.0 mm, and the reinforcement patch has a thickness ranging from 0.7 mm to 4.0 mm.

5. The method of claim 1, wherein the reinforcement patch is provided as a tailor welded blank before joining the reinforcement patch to the base.

6. The method of claim 1, wherein the reinforcement patch is provided as a tailor rolled blank before joining the reinforcement patch to the base.

7. The method of claim 1, wherein the step of joining the reinforcement patch to the base includes welding.

8. The method of claim 7, wherein the welding includes at least one of friction stir welding, spot welding, and laser welding.

9. The method of claim 1, wherein the method includes hot forming the reinforced blank, and the hot forming includes heating the reinforced blank in a furnace, transferring the heated reinforced blank to a forming device, and forming the reinforced blank in the forming device while the reinforced blank is at a temperature ranging from 400° C to 500° C to form the hot formed reinforced part, and quenching the hot formed part in the forming device.

10. The method of claim 9, wherein the step of heating the reinforced blank includes convection heating, jet heating, or contact heating.

11. The method of claim 1 including warm forming the reinforced blank, the warm forming including heating the reinforced blank in a furnace, transferring the heated reinforced blank to a forming device, and forming the reinforced blank in the forming device while the reinforced blank is at a temperature ranging from 170° C to 230° C.

12. The method of claim 1, wherein the warm forming or hot forming includes heating the reinforced blank in a furnace, and the method further including pre-heating the reinforcement patch prior to heating the reinforced blank in the furnace.

13. The method of claim 1 further including anodizing at least a portion of the reinforced blank, coating at least a portion of the reinforced blank with a heat absorbing coating prior to the warm forming or the hot forming, or enhancing the surface structure of the reinforced blank.

14. The method of claim 1, wherein the warm forming or hot forming includes heating the reinforced blank in a furnace, and the method further including post-heating at least a portion of the reinforced blank including the reinforcement patch after heating the reinforced blank in the furnace.

15. The method of claim 1, wherein the hot forming or warm forming the reinforced blank is conducted in a stamping or pressing tool which includes a die designed to accommodate the shape of the reinforced blank.

16. The method of claim 1, wherein the reinforced part has the shape of an A-pillar, A-pillar reinforcement, side member, B-pillar, B-pillar reinforcement, hinge pillar, roof rail, header, roof bow, door ring, double door ring, front rail, rear rail, side reinforcement, rocker rail, rocker panel, firewall upper, firewall lower, firewall reinforcement, tunnel, or tunnel reinforcement.

17. The method of claim 1, wherein the reinforced part has the shape of a side member of a battery tray, cross member of a battery tray, reinforcement of a battery tray, corner reinforcement, battery tray cover, or battery tray cover reinforcement.

18. A reinforced part, comprising:
a reinforcement patch joined to a base, wherein both the reinforcement patch and the base are formed of aluminum-based material.

19. A method of manufacturing a reinforced blank, comprising the steps of:
joining a reinforcement patch formed of aluminum-based material to a base formed of aluminum-based material prior to any forming step.

20. A reinforced blank, comprising:
a reinforcement patch formed of aluminum-based material joined to a base formed of aluminum-based material.
